(19) United States
(12) Patent Application Publication
(10) Pub. No.: US 2012/0134772 A1
(43) Pub. Date: May 31, 2012

(54) Transportable Bin

(76) Inventors: Alvin Herman, Saskatoon (CA); Erin Herman, Clavet (CA)

(21) Appl. No.: 12/956,445

(22) Filed: Nov. 30, 2010

(51) Int. Cl. B60P 1/16; B60P 1/04; B65G 65/30

(52) U.S. Cl. 414/808; 280/30

(57) ABSTRACT

A transportable apparatus may include a bin having a first end, a second end, and a wall connecting the first end and the second end; a frame configured to support the bin in a transport position; and a base configured to support the bin in a working position. At least a portion of the wall may have a non-circular curved cross-section having a major dimension and a minor dimension. A method may include providing a transportable apparatus, moving a bin of the transportable apparatus from a transport position to a working position, and providing material within the bin.

### BACKGROUND

The present invention relates to equipment and methods useful in storing material, and more particularly, to transportable bins for storing granular solids, and the like.

In many industries an array of equipment may be set up at a temporary work site, disassembled, and moved to another work site before reassembly. For example, asphalt and concrete plants may be set up in locations where large quantities of material are required for road or building construction. Similarly well drilling rigs, such as those drilling for oil and gas, may be set up at a drilling location, and subsequently taken down and moved to a different drilling location.

These portable plants and rigs may include various tanks, bins, silos, and the like for water, asphalt, sand, cement, and other materials as required at the particular work site. These are transported to the work site, often in a lowered horizontal transport orientation, and then raised to a vertical working orientation at the work site. For example, bins containing dry material especially may be elongated vertically when in a working position to maximize the quantity of material stored above a hoppered bottom such that the dry material may flow out by gravity. This vertical orientation may also reduce the ground area, or footprint, occupied by the installation. For example in well drilling installations it may be necessary to have a number of different materials located in proximity to the well being drilled, and the vertical orientation of tanks and bins facilitates such proximity. In other installations, it may also be desirable to minimize the area occupied.

Flat bed trucks or trailers may carry bins or tanks to the work site. In such instances, the trailer may be maneuvered into position, and then the bin may be raised from the horizontal transport position to the vertical working position resting on the ground, before the trailer is moved away from the site. A loader machine, crane, or the trailer itself may tilt the bin up to the vertical, or near vertical position. For example, CA 2,600,216 to Herman et al., which is hereby incorporated by reference in its entirety, illustrates some exemplary methods of tilting a bin to a vertical position.

### SUMMARY

The present invention relates to equipment and methods useful in storing material, and more particularly, to transportable bins for storing granular solids, and the like.

In some embodiments, a transportable apparatus may comprise a bin having a first end, a second end, and a wall connecting the first end and the second end; a frame configured to support the bin in a transport position; and a base configured to support the bin in a working position. At least a portion of the wall may have a non-circular curved cross-section having a major dimension and a minor dimension.

In some embodiments, a method may comprise providing an apparatus comprising a bin, a frame, and a base. The bin may have a first end, a second end, and a wall connecting the first end and the second end. At least a portion of the wall may have a non-circular curved cross-section having a major dimension and a minor dimension. The frame may be configured to support the bin in a transport position. The base may be configured to support the bin in a working position. The method may include moving the bin from the transport position to the working position, and providing material within the bin.

The features and advantages of the present invention will be readily apparent to those skilled in the art. While numerous changes may be made by those skilled in the art, such changes are within the spirit of the invention.

### BRIEF DESCRIPTION OF DRAWINGS

These drawings illustrate certain aspects of some embodiments of the present invention, and should not be used to limit or define the invention.

FIG. 1 is a side elevation view of a transportable apparatus, in accordance with one embodiment of the present invention.

FIG. 2 is a cross-sectional view of the transportable apparatus of FIG. 1, taken along line 2-2 of FIG. 1.

FIG. 3 is a perspective view of the transportable apparatus of FIGS. 1 and 2.

FIG. 4 is a perspective view of the transportable apparatus illustrating a base in an expanded position.

FIG. 5 is a perspective view of the base in a contracted position.

FIG. 6 is a perspective view of the base in an expanded position.

While the present invention is susceptible to various modifications and alternative forms, a specific exemplary embodiment thereof has been shown by way of example in the drawings and is herein described in detail. It should be understood, however, that the description herein of specific embodiments is not intended to limit the invention to the particular form disclosed, but on the contrary, the intention is to cover all modifications, equivalents and alternatives falling within the spirit and scope of the invention as defined by the appended claims.

### DETAILED DESCRIPTION

The present invention relates to equipment and methods useful in storing material, and more particularly, to transportable bins for storing granular solids, and the like. In some embodiments, a non-circular curved bin may enhance volume, while allowing for standard towing equipment to be used for transport, and providing adequate support to contain materials therein when in a working position. Such a shape may provide strength similar to that of a cylinder in the working position, while providing flexibility in transport by allowing for an increased major and reduced minor dimension as compared to a circular bin of the same volume. Such reduced minor dimension may allow bins to be transported on public throughways without restrictions placed on certain large vehicles. Because vehicles exceeding certain size limits may be excluded from passage in some locations, and/or may be required to travel with pilot vehicles, the reduced dimension may provide savings in cost and time when transporting bins.

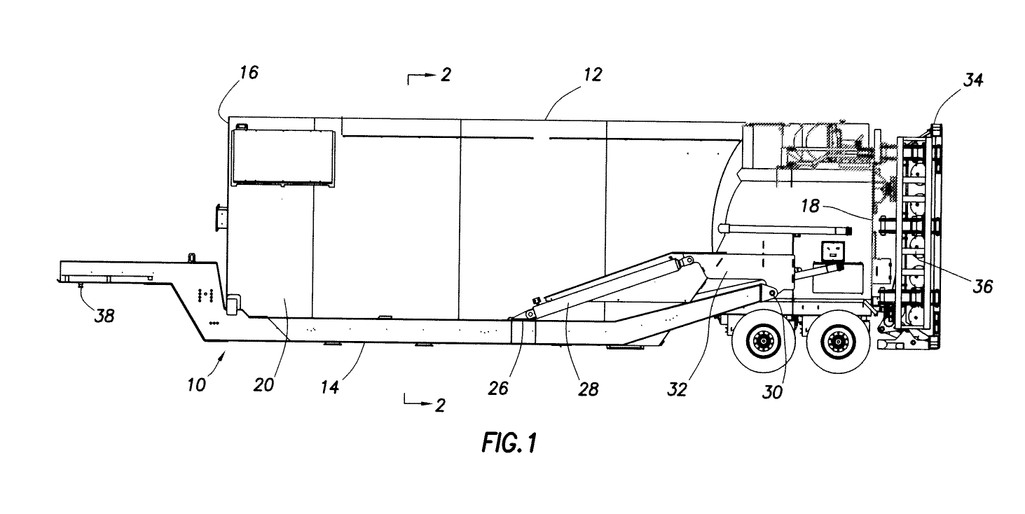

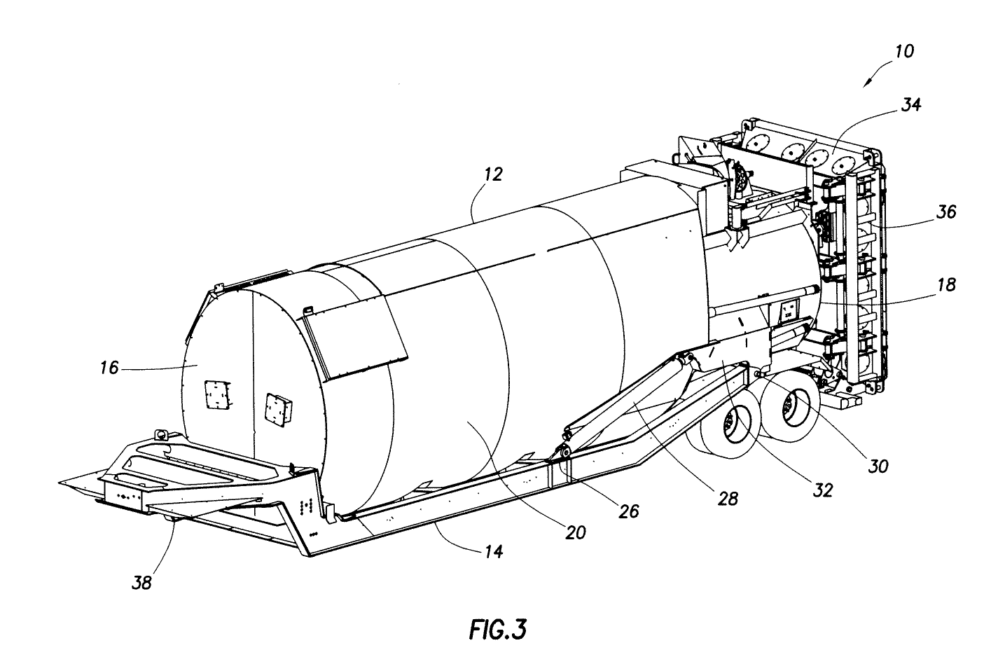

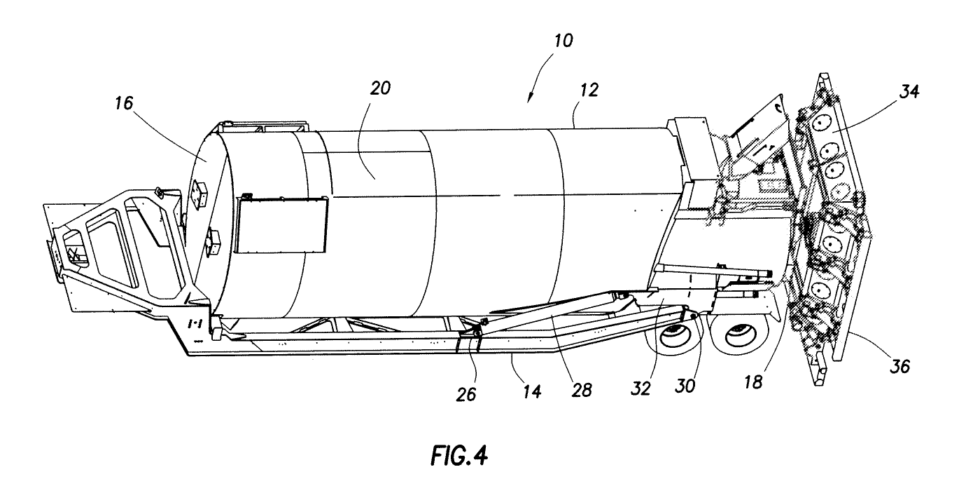

Referring to FIGS. 1-4, transportable apparatus 10 may be used to store any of a number of materials, such as sand, bauxite, ceramic materials, glass materials, resin precoated proppant (e.g., commercially available from Borden Chemicals and Santrol, for example, both from Houston, Tex.), polymer materials, TEFLON (tetrafluoroethylene) materials, nut shells, ground or crushed nut shells, seed shells, ground or crushed seed shells, fruit pit pieces, ground or crushed fruit pits, processed wood, composite particulates prepared from a binder with filler particulate including silica, alumina, fumed carbon, carbon black, graphite, mica, titanium dioxide, meta-silicate, calcium silicate, kaolin, talc, zirconia, boron, fly ash, hollow glass microspheres, solid glass, other dry materials, liquids, other fluids, and mixtures thereof. These materials may include those useful in oil and gas operations. Apparatus 10 may include bin 12 and frame 14. Bin 12 may have first end 16 and second end 18 and wall 20 between first end 16 and second end 18. Bin 12 may further include any number of structural supports to maintain a particular shape or otherwise provide stability, as will be appreciated by one having ordinary skill in the art.

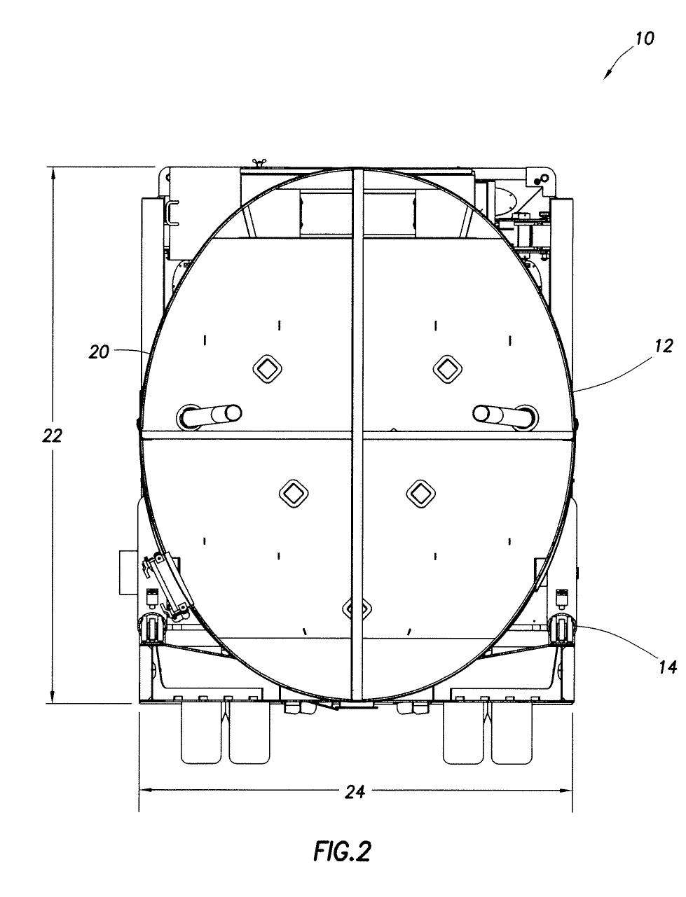

Wall 20 may connect first end 16 and second end 18, to form bin 12. A portion of wall 20 may curve, such that wall 20, first end 16, and second end 18 may form a complete enclosure. While portions of wall 20 curve in a circular fashion, wall 20 preferably has a non-circular curved cross-section over at least a portion of bin 12, as illustrated in FIG. 2. As used herein, “curved” does not imply any particular degree of curvature, but instead means any shape or portion of a shape that is not straight. Thus, a single sheet of material may form wall 20, or multiple sheets of material may connect to form an obround, oblong, elliptical, ovular, or any other tubular type form useful as a wall. Alternatively, extrusion or other methods of providing a tubular type form may provide a form for wall 20. As indicated in the illustrations, wall 20 need not be a continuous form, but can rather include portions that are wider (e.g., near first end 16) and portions that are narrower (e.g., near second end 18). One having ordinary skill in the art and the benefit of this disclosure will be able to determine the materials and methods for forming wall 20. Likewise, wall 20 may be attached or connected to first end 16 and second end 18 via any of a number of methods known by those having ordinary skill in the art. For example, welding may connect wall 20 to itself, and to first end 16 and second end 18.

Wall 20 may have a uniform cross-section, or wall 20 may have a variable cross-section, as indicated in FIGS. 1, 3, and 4. Preferably, at least a portion of wall 20 has a non-circular curved cross-section having major dimension 22 and minor dimension 24. As used herein, “major dimension” refers to the largest dimension from one side to another side of a curved non-circular shape and “minor dimension” refers to the smallest dimension from one side to another side, while still passing through a center of a curved non-circular shape. Thus, major dimension 22 is necessarily larger than minor dimension 24 in any curved non-circular shape, including obround, oblong, elliptical, and ovular shapes. Any number of other curved non-circular shapes also exist, including a circle flattened at least partially on one or more sides, an egg shape, a leaf shape, and the like. In some dimensions, a wall with a substantially cylindrical cross-section may be formed having a diameter of approximately 11′ before being compressed to have a minor dimension of less than approximately 10′, and causing a major dimension to be about 12′. Bars or other internal or external structures may maintain the bin in such a configuration. Alternatively, a roller may form the wall, or the wall may be preformed. Further, other methods for assembling wall 20 will be apparent to those having ordinary skill in the art.

In some embodiments, major dimension 22 and/or minor dimension 24 are substantially constant along wall 20, or portions of wall 20. In some embodiments, one or both of first end 16 and second end 18 is also a non-circular curve having a major dimension and a minor dimension. In some embodiments, first end 16 and/or second end 18 may be square, rectangular, or other shapes. In some such embodiments, such shapes may form a junction with wall 20 that is a curved non-circular shape, leaving an overhang of first end 16 and/or second end 18 beyond the limits of bin 12. Such shapes function as non-circular curves, as the excess or overhang (i.e. the area beyond wall 20) is not part of the volume of bin 12. In various configurations, major dimension 22 of wall 20 may correspond to the major dimension of first end 16 and/or second end 18. Likewise, minor dimension 24 of wall 20 may correspond to the minor dimension of first end 16 and/or second end 18. Thus, the major dimension of first end 16 and the major dimension of second end 18 may be substantially equal to major dimension 22 of wall 20, and the minor dimension of first end 16 and the minor dimension of second end 18 may be substantially equal to minor dimension 24 of wall 20.

Frame 14 may be configured to support bin 12 in a transport position, such as the position illustrated in FIGS. 1, 3, and 4. Frame 14 may attach pivotally at point 26 to actuator 28, which may in turn attach to bin 12 at pivot point 30 near second end 18 of bin 12. As illustrated, actuator 28 includes plate 32. However, alternate configurations would be readily apparent to one skilled in the art. Frame 14 may be a trailer, as illustrated in the figures, a pallet, a skid, or any other support structure useful in transporting cargo, including transport via land, sea, or air. In land embodiments, wheels may support frame 14, either partially or wholly, when bin 12 is in a transport position.

Actuator 28 may cause bin 12 to pivot from a transport position to a working position, or vice versa. Actuator 28 may be an extendable cylinder, such as, for example, a hydraulic cylinder. For example, when bin 12 is in a transport position where frame 14 is substantially parallel to bin 12, actuator 28 may extend, causing bin 12 to pivot away from frame 14 to an elevated or substantially vertical working position where frame 14 is substantially perpendicular to bin 12. On the other hand, when bin 12 is in a working position, actuator 28 may retract, causing bin 12 to pivot toward frame 14 to a lowered or substantially horizontal transport position. A transport position may be a position where bin 12 is substantially horizontal, such that first end 16 and second end 18 are substantially vertical planes and wall 20 is in a substantially horizontal position, with a centerline of bin 12 being substantially parallel to the ground or other surface on which frame 14 rests. A working position, on the other hand, may be a position where bin 12 is substantially vertical, such that first end 16 is elevated above second end 18 with first end 16 and second end 18 being substantially horizontal planes with wall 20 in a substantially vertical position, with a centerline of bin 12 being substantially perpendicular to the ground or other surface on which frame 14 rests. Thus, in the working position, apparatus 10, or any portion thereof (such as bin 12), may fit in a smaller ground area, or footprint, than in the transport position.

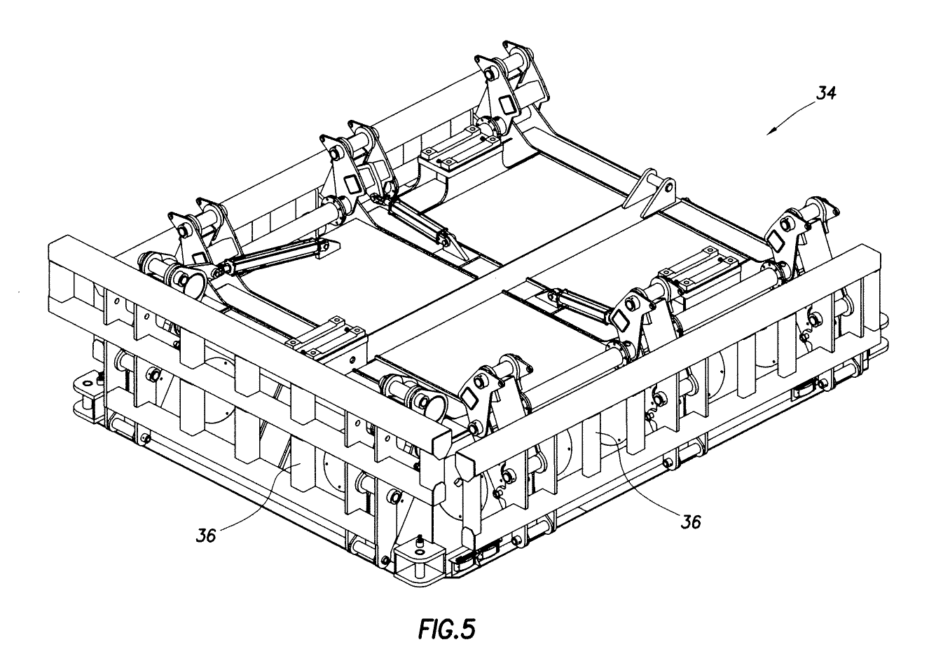

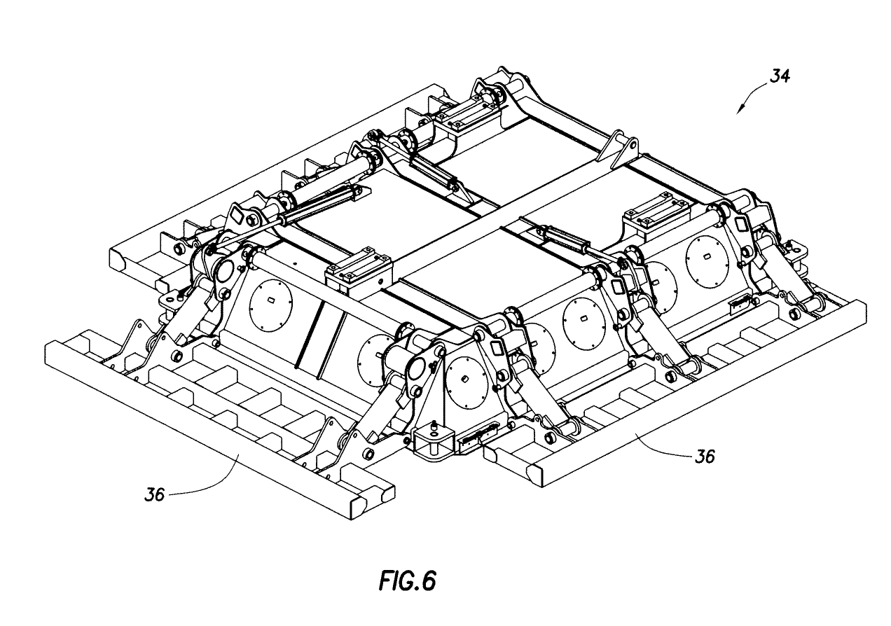

Optional base 34 may be configured to support bin 12 in the working position, which may be desirable when the height of bin 12 in the working position is large. Base 34 may be configured to expand from a transport size, illustrated in FIG. 5, to a working size, illustrated in FIG. 6. As illustrated, base 34 may include any number of rails 36 configured to pivot outward from base 34, such that base 34 expands or is enlarged from an initial dimension to a secondary dimension on each of four sides. For example, base 34 may expand approximately 20% in any given direction. In some embodiments, this expansion may be between approximately 0% and approximately 50% in one or more direction. Base 34 may expand approximately 2′ in any given direction. In some embodiments, this expansion may be between approximately 0′ and approximately 5′ in one or more directions. The transport size may be, for example approximately 10′ square or approximately 10′× approximately 13′8″, or any of a number of sizes between approximately 5′×5′ and approximately 14′×14′. The working size may be, for example, about 14′×14′, or any of a number of sizes between approximately 10′×10′ and approximately 20′×20′. While base 34 is illustrated and described as rectangular or square, base 34 may be formed in any suitable shape or size and may not have rails 36, but instead may have other means of expanding the effective footprint of bin 12. For example, base 34 may include one or more feet or other projections to anchor one or more sides of bin 12, without the need for a separate square or rectangular structure.

The ability of base 34 to expand from the transport size to the working size may allow for additional stability when used in conjunction with bin 12 in the working position. Base 34 may be connected or attached to second end 18 of bin 12, such that base 34 supports bin 12 under various load conditions. Base 34 may be fixedly attached to bin 12, such that base 34 is substantially vertical during transport of apparatus 10, or base 34 may be removably attached or completely separate from bin 12, so long as base 34 can support bin 12 in a working position. In particular, base 34 may be configured to support bin 12 on flat horizontal surfaces, slanted surfaces, or other surfaces typical in oilfield operations. Base 34 may also be configured to support bin 12 in various weather conditions, including windy conditions (e.g., tornado force winds) on bin 12, including when bin 12 is partially or completely empty. For example, base 34 and bin 12 may be designed to withstand 70 mph winds for 2 minutes when bin 12 is empty.

In various embodiments, the selection of major dimension 22 and minor dimension 24 may allow for transport on U.S. highways without the need for a pilot vehicle. For example, major dimension 22 may be no more than approximately 12′4″. In various embodiments, major dimension 22 may be between approximately 10′ and 13′8″. In other embodiments, major dimension 22 may be between approximately 8′ and 10′. Likewise, minor dimension 24 may be less than approximately 10′ for example. In various embodiments, minor dimension 24 may be between approximately 9′ and 14′. In other embodiments, minor dimension 24 may be between approximately 6′ and 9′. In various embodiments, major dimension 22 may be at least 20% greater than minor dimension 24. In certain embodiments, major dimension 22 may be no more than 50% greater than minor dimension 24. In some embodiments, major dimension 22 may be at least 1′ greater than minor dimension 24. In some embodiments, major dimension 22 may be no more than 5′ greater than minor dimension.

Various methods of transporting or storing materials may use apparatus 10. For example, one method may include providing apparatus 10 as described above, moving bin 12 from the transport position to the working position, and placing material within bin 12. Moving apparatus 10 may include connecting frame 14 to a tow vehicle and towing apparatus 10 from a first location to a second location, or any other method of moving apparatus 10 from one location to another, via land, sea, or air. For example, a tow vehicle (not shown), such as a truck, may be attached to hitch 38 formed in frame 14, with apparatus 10 in a transport position, and tow vehicle, and attached apparatus 10 may be moved to a worksite. Once at the worksite, the tow vehicle may be removed, leaving apparatus 10, and any supports (such as wheels). Alternatively, the tow vehicle and supports may be removed after apparatus 10 has been moved into a working position.

Actuator 28 may move apparatus 10 to the working position immediately. However, if second end 18 of bin 12 is insufficient to support bin 12 in the working position, base 34 may be supplied to provide stability. Base 34 may be attached to bin 12 prior to transport, or base 34 may be attached to bin 12 at the worksite. In some embodiments, bin 12 may rest on base 34 via gravity, without any firm attachment. If base 34 is attached to bin 12 prior to transport, and in some other instances, it may be desirable to expand base 34 from the transport size to the working size. Once base 34 is ready for bin 12, bin 12 may be moved from the transport position to the working position and set on base 34 such that base 34 supports bin 12. In embodiments where base 34 is connected to bin 12, the process of setting bin 12 on base 34 merely requires actuator 28 to position apparatus 10 in the working position, without alignment of bin 12 and base 34. One method of moving bin 12 from the transport position to the working position includes hydraulically or otherwise lifting first end 16 of bin 12 until first end 16 is above second end 18, which rests on base 34. However, other suitable methods for moving bin 12 from the transport position to the working position exist as would be appreciated by one having ordinary skill in the art. Once in a working position, locks may be provided to secure bin 12, base 34, and/or frame 14 in position.

Once bin 12 is in the working position, at least some material can be added and/or removed from bin 12 as conditions for particular operations dictate. After bin 12 has been partially or completely emptied, bin 12 can be unlocked and returned to the transport position and transported from the work site. Returning bin 12 to the transport position may involve use of actuator 28, or other methods. In some embodiments, a tow vehicle or other transport device may engage apparatus 10 prior to moving bin 12 to a transport position. Such engagement may provide additional stability during the transition from working position to transport position.

Materials suitable for storage in apparatus 10 include dry materials. In some embodiments, bin 12 is configured to contain the dry material without plastic deformation. More particularly, bin 12 may be configured to carry the dry material in the transport position and/or store the material in the working position, without plastic deformation. In other embodiments, bin 12 is configured to contain any of a number of fluids, whether liquid, particulate, or combinations thereof, without substantial deformation. For example, bin 12 may contain fluids therein in the transport position and/or the working position without variation in excess of approximately 1% in either major dimension 22 or minor dimension 24. In other embodiments, variation in major dimension 22 and/or minor dimension 24 is limited to approximately 5%, 10%, 15% or less.

In some embodiments, bin 12 may have a volume of approximately 2500 ft³. In some embodiments, the volume may be between approximately 500 ft³ and 5000 ft³. In some embodiments, bin 12 may be replaced with any type of large object, including, but not limited to a tank, silo, machine, or equipment, for which a substantially horizontal transport position and a substantially vertical working position on a base is desirable. For example, a substantially vertical working position may be desirable to provide a relatively compact horizontal space, or footprint, at a worksite.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. In addition, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A transportable apparatus comprising:
a bin having a first end, a second end, and a wall connecting the first end and the second end, wherein at least a portion of the wall has a non-circular curved cross-section having a major dimension and a minor dimension;
a frame configured to support the bin in a transport position; and
a base configured to support the bin in a working position.

2. The transportable apparatus of claim 1, wherein the base is configured to expand from a transport size to a working size.

3. The transportable apparatus of claim 1, wherein at least one of the first end and the second end comprises a non-circular curve having a major dimension and a minor dimension.

4. The transportable apparatus of claim 1, wherein the major dimension and the minor dimension are each substantially constant along the wall.

5. The transportable apparatus of claim 4, wherein both the first end and the second end are non-circular curves having a major dimension and a minor dimension, wherein the major dimension of the first end and the major dimension of the second end are substantially equal to the major dimension of the wall, and wherein the minor dimension of the first end and the minor dimension of the second end are substantially equal to the minor dimension of the wall.

6. The transportable apparatus of claim 1, wherein the non-circular curved cross-section is obround, oblong, elliptical, or ovular.

7. The transportable apparatus of claim 1, wherein the major dimension is no more than 12′4″ and wherein the minor dimension is less than 10′.

8. The transportable apparatus of claim 1, wherein the major dimension is at least 20% greater than the minor dimension.

9. The transportable apparatus of claim 1, wherein the major dimension is no more than 50% greater than the minor dimension.

10. The transportable apparatus of claim 1, wherein the major dimension is at least 1′ greater than the minor dimension.

11. The transportable apparatus of claim 1, wherein the major dimension is no more than 5′ greater than the minor dimension.

12. The transportable apparatus of claim 1, wherein the bin is configured to store dry material at a worksite without plastic deformation.

13. A method comprising:
providing an apparatus comprising:
a bin having a first end, a second end, and a wall connecting the first end and the second end, wherein at least a portion of the wall has a non-circular curved cross-section having a major dimension and a minor dimension;
a frame configured to support the bin in a transport position; and
a base configured to support the bin in a working position;
moving the bin from the transport position to the working position; and
placing material within the bin.

14. The method of claim 13, wherein the base is configured to expand from a transport size to a working size, the method comprising expanding the base from the transport size to the working size.

15. The method of claim 13, comprising attaching the base to the bin.

16. The method of claim 13, comprising setting the bin on the base, such that the base supports the bin in the working position.

17. The method of claim 16, wherein moving the bin from the transport position to the working position comprises hydraulically lifting the first end of the bin.

18. The method of claim 16, comprising removing at least some material from the bin.

19. The method of claim 13, comprising moving the apparatus by connecting the frame to a tow vehicle and towing the apparatus with the tow vehicle from a first location to a second location.
